(19) United States
(12) Patent Application Publication
(10) Pub. No.: US 2022/0376247 A1
(43) Pub. Date: Nov. 24, 2022

(54) Anode-Free Electrochemical Cell

(71) Applicant: Zeta Energy LLC, Houston, TX (US)

(72) Inventors: Abdul-Rahman Olabode Raji, Houston, TX (US); Rodrigo Villegas Salvatierra, Houston, TX (US); Tuo Wang, Houston, TX (US)

(21) Appl. No.: 17/568,812

(22) Filed: Jan. 5, 2022

Related U.S. Application Data
(60) Provisional application No. 63/191,533, filed on May 21, 2021.

(51) Int. Cl. H01M 4/583; H01M 4/66

(52) U.S. Cl. CPC H01M 4/583; H01M 4/661

(57) ABSTRACT

An anodeless cell with an anode-side current collector and a cathode active surface that supports a layer of anode material. The cathode active material includes a conductive framework of tangled nanofibers with lumps of amorphous carbon-sulfur and the anode material distributed within them. During cell formation, the anode material of the layer and within the cathode material is electrodeposited on the anode current collector to form the anode. The combined anode material within and on the cathode material is more than is required for anode formation. The excess anode material can be removed, and some can be left in the cell to offset losses due to side reactions.

### BACKGROUND

An electric battery includes one or more electric cells. Each cell includes a positive electrode (cathode) and a negative electrode (anode) physically separated by an ion conductor (electrolyte). When a cell is discharged to power an external circuit, the anode supplies negative charge carriers (electrons) to the cathode via the external circuit and positive charge carriers (cations) to the cathode via the internal electrolyte. During charging, an external power source reverses this process, driving electrons from the cathode toward the anode via the power source and cations from the cathode to the anode via the electrolyte.

Lithium-ion (Li-ion) batteries store charge in the anode as Li cations (aka Li ions, or Li+). Li-ion batteries are rechargeable and ubiquitous in mobile communications devices and electric vehicles due to their high energy density, a lack of memory effect, and low self-discharge rate. Lithium-metal (Li-metal) batteries store charge in the anode as Li metal (aka Li or pure Li), which is superior to Li ions due to a higher theoretical specific capacity, lower electrochemical potential, and lower density. Unfortunately, rechargeable Li-metal batteries have yet to be commercialized, mainly due to the growth of electrically conductive Li dendrites that can extend from anode to cathode providing a destructive and potentially dangerous internal short. Also troubling, Li metal produces side reactions with the electrolyte that consume the Li and increase cell impedance. Both dendrites and Li side reactions reduce cell life below levels that are commercially viable for important markets.

### BRIEF DESCRIPTION OF THE FIGURES

The present invention is illustrated by way of example, and not by way of limitation, in the figures of the accompanying drawings and in which like references refer to similar elements and in which:

FIG. 1A depicts an anodeless, or anode-free, storage cell 100 in accordance with one embodiment.

FIG. 1B depicts an anode-free storage cell 150 in accordance with another embodiment.

FIG. 2 shows three cross sections of cell 100 of FIG. 1A in various states of charge and discharge.

FIG. 3 depicts a rechargeable energy storage cell 300 that is similar to storage cell 100 of FIG. 1A with like-identified elements being the same or similar.

FIG. 4 is a SEM image at 80,000× magnification of an active surface of an electrode 400, a cathode for use in an energy-storge device.

FIG. 5 is a SEM image of the active surface of electrode 400 at 1,000× magnification.

FIG. 6 is an SEM image of electrode 400 in cross section at 4,000× magnification.

FIG. 7 is a flowchart depicting a method 700 of forming electrode 400 to make e.g. a cathode for an energy-storage device.

FIG. 8 depicts carbon nanotubes 800 at 40,000× magnification.

FIG. 9A depicts a thermogravimetric (TG) plot 900 and differential scanning calorimetric (DSC) plot 905 of the precursor mixture from step 705 of FIG. 7.

FIG. 9B depicts the Raman spectrum of the precursor mixture from step 705 of FIG. 7.

FIG. 10A depicts a TG plot 1000 and DSC plot 1005 of the output from step 735 of FIG. 7, the active cathode layer 300 in accordance with the embodiment of FIG. 1A.

FIG. 10B is a Raman spectrum of a conductive framework of sulfurized carbon showing carbon sulfur (C—S) peaks, sulfur (S) peaks, D, G, and 2D peaks.

FIG. 11A plots the cycling performance (charge/discharge) of an electrode in accordance with one embodiment.

FIG. 11B plots the rate performance (charge/discharge) of an electrode (a half cell) in accordance with another embodiment.

### DETAILED DESCRIPTION

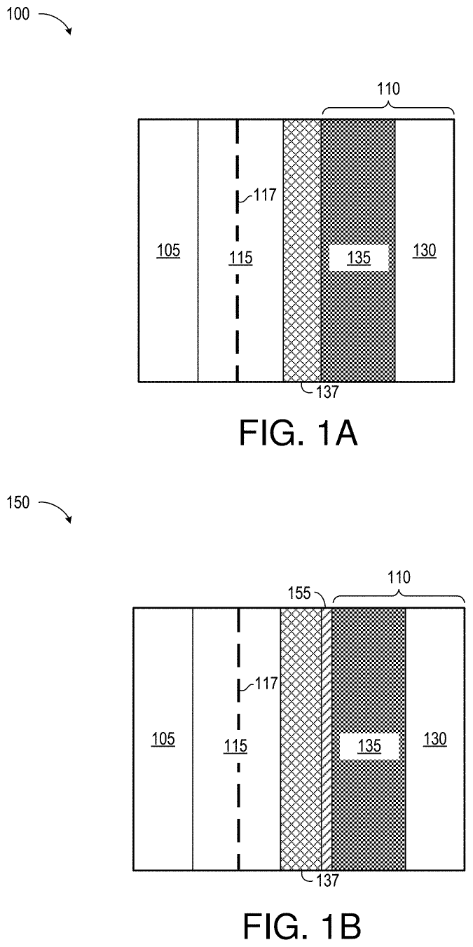

FIG. 1A depicts an anodeless, or anode-free, storage cell 100 in accordance with one embodiment. Anodeless cells are those assembled without active anode material, commonly Li metal, at the anode side of the cell. Instead, the anode active material is on the cathode side. When an anodeless cell is first charged, Li ions are removed from the cathode side, diffuse through the electrolyte, and are electrodeposited as metallic Li onto an anode-side current collector. Thereafter, the metallic Li, serving as the active anode material, can be reversibly stripped from and deposited onto the anode current collector. Excess anode material at the cathode prior to cell assembly can replace material lost to side reactions, and thus improve cell life.

An anode-side current collector 105 of e.g. copper is matched with a cathode 110 with a current collector 130 of e.g. aluminum bearing a layer of cathode material 135. The anode and cathode sides of cell 100 are separated by an electrolyte 115 with a separator 117 of, e.g., a porous polymer. Other embodiments employ a solid electrolyte instead of or in addition to a liquid, in which case the separator can be omitted. An alkali-metal layer 137 (e.g. of Li) between electrolyte 115 and cathode material 135 provides anode material to be deposited on anode current collector 105. After cell assembly, the Li of layer 137 is ionized and moved to current collector 105 via electrolyte 115 and separator 117 where it covers current collector 105 to form an anode. During discharge, this anode-side Li returns to the cathode side where it is absorbed within cathode layer 135.

Cathode layer 135 can be e.g. vanadium pentoxide, copper chloride, manganese dioxide, porous carbon, or a carbon-sulfur composite. An embodiment in which cathode layer 135 is a nanoporous carbon-sulfur composite formed using a mixture of porous carbon and sulfur is detailed below. In that embodiment, the porous carbon collectively forms a matrix that improves thermal and electrical conductivity, traps harmful polysulfides that would otherwise migrate away from cathode 110, and accommodates expansion and contraction that accompanies the addition and depletion of Li.

Li layer 137 can be a continuous or perforated Li foil. The mass of layer 137 is selected such that both cathode layer 135 and the anode layer formed on current collector 105 during cell formation have the capacity to store the entire amount, between twenty and forty microns thick in one non-porous embodiment. The anode material, being pure metal, supports a higher energy density than anodes in conventional Li-ion cells because the latter include some amount of porous carbon to store the Li ions.

FIG. 1B depicts an anode-free storage cell 150 in accordance with another embodiment. Storage cell 150 resembles cell 100 of FIG. 1A, with like-identified elements being the same or similar. Cell 150 additionally includes a powdered or electroplated dopant layer 155 of aluminum between Li layer 137 and cathode layer 135. Layer 155 is exaggerated for ease of review but would be atomic in scale (e.g. greater than 5 μm thick). Alternatively, layers 137 and 155 can be combined as a Li-aluminum alloy, and the dopant can be e.g. boron rather than aluminum. During anode formation, a process detailed below, the material from layer 155 migrates into cathode layer 135 where it remains.

Cathode layer 135 can include sulfurized carbon (SC) that serves as active cathode material. In some such embodiments, the active cathode material includes elements like nitrogen and oxygen that are more electronegative than carbon and sulfur, and thus tend to disadvantageously pull electrons away from the electrically conductive carbon. The majority material of dopant layer 155, a majority of layer 155 by atomic percent, has a lower electronegativity than nitrogen and oxygen and thus counteracts the impact of those dopants when incorporated into the active cathode material. As a consequence, cathode layer 135 has a higher lithium storage capacity.

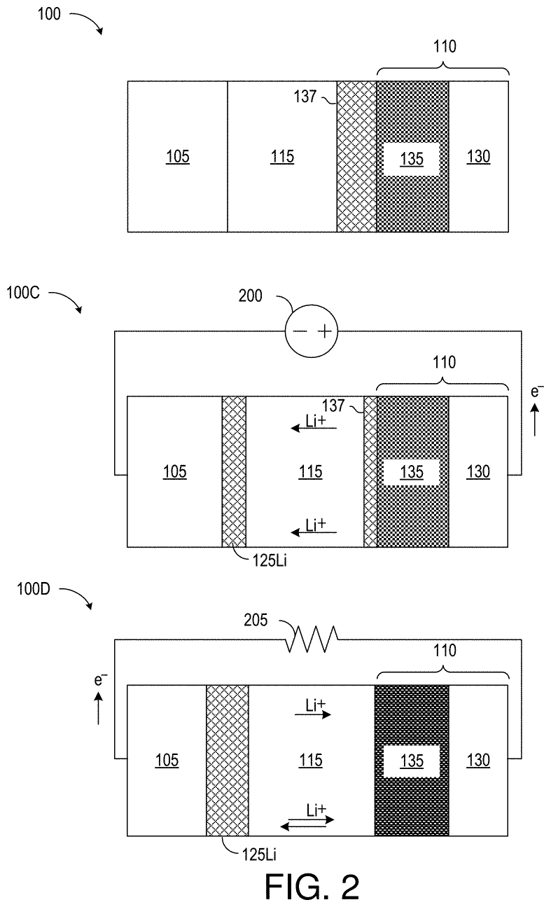

FIG. 2 shows three cross sections of cell 100 of FIG. 1A in various states of charge and discharge. Beginning with the uppermost example, labeled 100, the active material within cell 100 is divided between Li layer 137 and cathode layer 135, with some Li ions dissolved in electrolyte 115. While within a discrete layer for ease of illustration, electrolyte 115 can also occupy the empty spaces within porous cathode layer 135. In some embodiments, one or more liquid electrolyte can be used on either or both sides of a solid electrolyte to facilitate ion transport. However configured, the cathode side of Li layer 137 is in physical and electrical contact with cathode layer 135 and is physically and electrically separated from current collector 105 before cell formation. Lithium layer 137 can be porous, such as perforated metal film or a layer of Li particles, in which case injected liquid electrolyte can find its way into Li layer 137 and the underlying cathode layer 135.

The middle example of cell 100 is labeled 100C, the “C” for charging. A power supply 200 draws electrons from cathode 110 and Li ions from layer 137 as the Li metal is oxidized. In a process called “electrostripping,” layer 137 is depleted as the material migrates as Li ions through electrolyte 115 to form an anode-side Li layer 125Li. Though not shown, Li layer 137 essentially disappears when the constituent metal is depleted, and additional Li from cathode layer 135 can be likewise transported to anode layer 125Li until cell 100C is fully charged. Experiment has shown that pre-wetting cathode layer 135 is not necessary because the electrolyte is drawn into porous surfaces either during electrolyte injection or Li-layer depletion.

The lowermost example of cell 100 is labeled 100D, the “D” for discharging. A load 205, represented as a resistor, allows electrons from the anode formed by current collector 105 and anode layer 125Li to migrate toward cathode 110 and Li ions from anode layer 125Li to migrate to cathode 110 to take up residence within cathode layer 135 and form Li sulfides. Layer 137 does not reform during subsequent charge and discharge cycles.

In one embodiment, the anode current collector and the cathode are separately fabricated into electrode sheets that are then cut into desired shapes. A sheet of separator material and Li foil are likewise cut to desired shapes to form a separator and Li layer 137. Cell 100 is assembled from these materials and filled with electrolyte. Lithiation then proceeds by electrostripping/electrodeposition to charge cell 100 as illustrated by cell 100C. In another embodiment, Li layer 137 is initially deposited on the cathode by e.g. physical vapor deposition. Thermal evaporation of Li, for example, can be used to produce a Li layer with good adhesion to the target surface.

Returning to the example of cell 100 of FIG. 1A, layer 135 is formed of a metallic reductant material, e.g. metallic Li, in the form of a foil, film, or coating placed before or during assembly of a cell, in contact with layer 135 of cathode active material. The cathode active material, e.g. SC, is physically and electrically connected to a first metallic current collector 130, e.g. of aluminum. These layers are assembled with a second metallic current collector 105, e.g. copper, bearing no anode active or host material, with the second current collector 105 separated from the metallic reductant/cathode layer 135. In some embodiments, layer 137 of metallic Li is retained in contact with cathode layer 135 in the final assembled cell 100 as a distinct metallic reductant layer. After a rest period of e.g. 24 h from cell assembly, some of the metallic Li will have reacted with the active material of cathode layer 135. Some of the cathode active material is converted to a Li compound, e.g. lithium sulfurized carbon (LiSC), with Li ions and electrons directly transferred to the SC to convert it to the LiSC compound. In some embodiments, a substantial amount of the metallic Li layer reacts with the active material of the cathode layer to convert most of the active material to a lithiated compound. The Li in the LiSC compound is no longer in the metallic state, but rather in the ionic state, and Li ions are atomically bonded to the SC, which carries the electrons. This conversion reaction occurs spontaneously and directly through physical contact between the metallic Li layer, a potent reductant, and the cathode layer, an oxidant. Herein, “spontaneous” denotes the occurrence of a reaction absent application of an external voltage. In some embodiments, heat (to attain a temperature up to e.g. 80° C.) is applied to speed up the conversion reaction and electrolyte diffusion. In some embodiments, some of the metallic Li layer is still present on the external surface of the cathode layer after the reaction with the active layer of the cathode layer. In some embodiments, electrolyte is added between the cathode layer and metallic Li of layer 137 to improve wetting of the cathode layer, promote adhesion between cathode layer and metallic Li layer, and facilitate Li-ion transport to the cathode active material. In some embodiments, an adhesion layer or coating of e.g. lithiophilic material such as sulfur, phosphorous, sulfur-phosphorous compound, zinc oxide, aluminum oxide, adhesive polymers, or resins such as acrylic resin or polyacrylic acid (PAA) is deposited on cathode layer 135 and thus disposed between cathode layer 135 and metallic Li layer 137. In some embodiments, material from the adhesive coating reacts with the metallic Li in layer 137 to form a Li compound. In some embodiments, the metallic Li layer 137 is perforated or porous to improve transport of electrolyte to and from the cathode layer.

The charge and discharge cycles applied to cell 100 and illustrated in FIG. 2 can be applied equally to electrode 150 of FIG. 1B. The alkali metal of layer 137 is electrostripped from the cathode side and deposited at the anode-side current collector 105. Material from dopant layer 155 is not electrostripped but remains at the cathode side where it is absorbed into cathode layer 135 over one or more charge/discharge cycles. Where layers 137 and 155 are replaced with a layer of a graded or homogeneous alloy of e.g. aluminum and Li, the electrostripping parameters selectively remove the anode material, Li in this example, to the anode side. In some embodiments, a voltage is applied to induce current and drive the metallic Li from the cathode surface to the anode-side current collector.

In some embodiments, all the metallic Li layer is utilized in forming Li sulfur (LiS) compounds during the formation cycle(s) after cell assembly. In some embodiments, a layer of excess metallic Li is retained on the surface of the cathode after formation of the LiSC and during cell cycling. In some embodiments, the LiSC compounds are formed before assembling the cell and the excess or remaining metallic Li layer used in the formation is removed. In some embodiments, the excess or remaining metallic Li layer is retained in the cell after forming the LiSC. In some embodiments, all the metallic Li layer is utilized in forming a LiS or LiSC compound during the formation cycle(s) before cell assembly. The reaction rate between the Li metal and the SC, and thus the rate at which the SC is lithiated, can be electronically controlled.

Cathode layer 135 can be predominantly of sulfur, and may include a sulfur compound or compounds, a sulfur-carbon composite, or another group 6A element (periodic table) as the active material, e.g. selenium. In some embodiments, the cathode layer may include phosphorous as an active material.

In some embodiments, metallic reductant layer 137 comprises a group 1A element (periodic table) other than Li, e.g. Na, K. In some embodiments, the metallic reductant layer comprises a group 2A element, e.g. Mg, Ca. In some embodiments, the metallic reductant layer comprises a transition metal element, e.g. Al, or a metalloid, e.g. B.

A liquid electrolyte, e.g. Li bis(fluorosulfonyl)imide in dimethoxyethane, Li hexafluorophosphate in an organocarbonate solvent, may also be used together with a polymer separator, e.g. polyethylene, polypropylene, in the cell. As a liquid, electrolyte can be e.g. 4 M Li bis(fluorosulfonyl)imide with a porous separator of e.g. 12 μpolyethylene.

A solid electrolyte can be used to separate the cathode side from the anode side, in which case one or both active layers can incorporate a liquid, paste, or jell electrolyte that facilitates ion flow between the solid electrolyte and the cathode and anode active materials. A solid electrolyte, e.g. lithium-phosphorous-sulfur electrolyte compound (Li₃PS₄ or LiₓP_{y}S, where x, y, and z >0) can be used with a liquid electrolyte and optionally a separator. The electrolytes on either side of the solid electrolyte can be the same or different, depending on what best suits the cathode and anode active materials. Solid, or “solid-state,” electrolytes can be inorganic (e.g. lithium phosphorous oxynitride (LiPON), lithium thiophosphate, lithium phosphorous sulfide, lithium phosphorous sulfur chloride, lithium aluminum titanium phosphate (LATP), lithium aluminum germanium phosphate (LAGP), sodium zirconium silicon phosphate, glassy lithium oxychloride, lithium nitride, garnet-type lithium aluminum lanthanum zirconium oxide (aluminum-doped LLZO), tantalum-doped LLZO, niobium-doped LLZO, gallium-doped LLZO) or organic polymer (e.g. polyethylene oxide).

In some embodiments, a layer of solid electrolyte is deposited on a metallic current collector, e.g. copper, and assembled with a layer or foil of metallic Li on the SC cathode to form an electrochemical cell. During charging, Li ions traverse the solid electrolyte and form a layer of metallic Li between the solid electrolyte and the current collector.

In some embodiments, a solid electrolyte is formed by converting a solid electrolyte precursor, e.g. phosphorous-sulfur compound (P₄S₁₀), to a lithiated solid compound, e.g. a lithium-phosphorous-sulfur compound (Li₃PS₄ or LiₓP_{y}S_{z} where x, y, and z >0). In some embodiments, the solid electrolyte is formed in situ (during charging) whereby the Li for the conversion comes from the cathode side. In some embodiments, a layer of metallic Li is in contact with the solid electrolyte precursor, e.g. P₄S₁₀, before or during cell assembly, whereby a reaction between the metallic Li and solid electrolyte precursor forms a lithiated solid compound (e.g. LiₓP_{y}S_{z} where x, y, and z >0), thus forming the solid electrolyte before charging the cell.

Current collectors are copper and aluminum films in the embodiment of FIG. 1A but can be of different materials or comprise e.g. tabs or terminals. The term “current collector” refers herein to any conductor that makes electrical contact with a portion or the entire surface of the electrode active materials to facilitate electron exchange. Cathodes can have different types and formulations of oxidants, e.g., from the families of oxides, fluorides, and phosphates.

An anodeless metal-sulfur electrochemical cell was assembled with components that included a cathode side comprising a layer of cathode active material, e.g. SC, coated on a first metallic foil current collector, e.g. aluminum foil and a layer of metallic reductant, e.g. metallic Li, on the exterior surface of the cathode active material; a second metallic foil current collector, e.g. copper, with no anode active material initially; and an ionic conductor (i.e. an electrolyte) between the first and second metallic foil current collectors. A liquid electrolyte, e.g. Li bis(fluorosulfonyl)imide in dimethoxyethane, may also be used together with a polymer separator, e.g. polyethylene, in the cell. A solid electrolyte and a liquid electrolyte can be used together, with or without a separator, or a solid electrolyte can be used alone.

To prepare the cathode, SC active material was mixed with carbon black and PAA at a ratio of 1:1:1 by weight using a planetary centrifugal mixer at 1500 rpm for 10 min. Then, water was added to the powder mixture, after which it was further mixed at 1500 rpm for 20 min to obtain a slurry. The slurry was blade-coated on a first metallic current collector, e.g. carbon-coated aluminum foil (14 μm, 1 μm carbon film on each side) to produce a coating, which was dried at 70° C. for 30 min in ambient air and further dried at 70° C. for 12 h in vacuum. An electrolyte containing 4 M Li bis(fluorosulfonyl)imide (LiFSI) salt dissolved in 1,2-dimethoxyethane (DME) solvent was added on the cathode layer. Then, a 35 μm thick metallic Li foil (14 mm diameter) was placed on the exterior surface of the cathode. The electrolyte added between the metallic Li layer and the cathode layer promoted adhesion between the metallic Li layer and the cathode layer. A polymer separator based on 12 μm polyethylene coated with 4 μm ceramic (e.g. aluminum oxide) was placed between the cathode and a second metallic foil current collector. A 16 mm diameter copper foil current collector (10 μm thick, 16 mm diameter) with no anode active material (e.g. metallic Li) on it was used as the second metallic foil current collector and placed on the separator. More liquid electrolyte, 4 M LiFSI salt dissolved in DME, was added to the cell to wet the components. The liquid electrolyte concentration of at least 2 M improved cycle performance compared with standard 1 M electrolyte concentration due to formation of more compact or denser solid electrolyte interphase (SEI) on metallic Li or cathode active material, with greater inorganic SEI components from the salt degradation products.

After assembly, the cell was rested for 24 h. This time was sufficient to cause the metallic Li to lithiate the SC active material of the cathode layer. The cathode active material was converted to LiSC. Because the assembled cell was in the discharged state after forming the LiSC or lithiated SC, the cell was charged to a voltage of 2.6 V by applying a current density of 0.2 mA cm⁻², equivalent to 0.1 C, which induced deposition (plating) of metallic Li on the copper current collector. The cell was then discharged at a rate of 0.1 C to a voltage of 1 V to dissolve the metallic Li from the copper foil surface and lithiate the SC. The cell was then cycled at a rate of at least 0.2 C multiple times.

In some embodiments, SC active material was mixed with carbon black and PAA in the ratio of 9:1:1 by weight, respectively, and mixed with water to form an aqueous slurry. The slurry was coated on a metallic current collector, e.g. carbon-coated aluminum, after which it was dried at 70° C. for 1 h in air and for at least 3 h under vacuum. A 35 μm thick metallic Li foil (14 mm diameter) was placed on the exterior surface of the cathode. 4 M LiFSI salt dissolved in DME was added to the cell to wet the metallic Li surface. A polymer separator based on 12 μm polyethylene coated with 4 μm ceramic (e.g. aluminum oxide) was placed between the cathode and a second metallic foil current collector. More 4 M LiFSI salt dissolved in DME was added to the cell to further wet the separator. A 16 mm diameter copper foil current collector (10 μm thick, 16 mm diameter) with no anode active material (e.g. metallic Li) on it was used as the second metallic foil current collector and placed on the separator. After cell assembly, the cell was rested for 24 h.

All the metallic Li layer can be utilized in forming LiSC compounds during the formation cycle(s) after cell assembly. A layer of excess metallic Li can be retained on the surface of the cathode after formation of the LiSC and during cell cycling. The LiSC compound can be formed before assembling the cell. With the LiSC formed, excess or remaining metallic Li at the cathode can be retained or removed. In some embodiments, all the metallic Li layer is utilized in forming LiSC compounds during the formation cycle(s) before cell assembly.

In some embodiments, SC active material was mixed with carbon black and PAA in the ratio of 9:1:1 by weight, respectively, and mixed with water to form an aqueous slurry, which was coated on a carbon-coated aluminum foil, a metallic current collector, after which it was dried at 70° C. for 1 h in air and for at least 3 h under vacuum. Current collectors of e.g. aluminum foil, etched aluminum foil, nickel foil, carbon-coated nickel foil, copper, carbon-coated copper foil, etched metallic foil, metallic foil mesh, carbon foil/paper, graphite foil, carbon nanotube foil, or graphene foil can also be used. A 35 μm thick metallic Li foil (14 mm diameter) was placed on the exterior surface of the cathode. A polymer separator based on 12 μm polyethylene coated with 4 μm ceramic (e.g. aluminum oxide) was placed between the cathode and a second metallic foil current collector. A 16 mm diameter copper foil current collector (10 μm thick, 16 mm diameter) with no anode active material was used as the second metallic foil current collector. Liquid electrolyte, 4 M LiFSI salt dissolved in DME, was added to the cell to wet the components. After cell assembly, the cell was rested for 24 h.

Layers 135 and 137 can have the same area. The area of layer 137 can be less than that of layer 135 (e.g. 1 mm smaller in each planar dimension) to facilitate electrolyte diffusion through and around the edges of layer 137.

In some embodiments, SC active material was mixed with carbon black and PAA in the ratio of 9:1:1 by weight, respectively, and mixed with water to form an aqueous slurry, which was coated on a first metallic current collector, e.g. carbon-coated aluminum, after which it was dried at 70° C. for 1 h in air and for at least 3 h under vacuum. A 35 μm thick metallic Li foil (14 mm diameter) was placed on the exterior surface of the cathode. A 16 mm diameter copper foil current collector (10 μm thick, 16 mm diameter) with no anode active material was used as a second metallic foil current collector and coated with a solid electrolyte precursor, e.g. phosphorous-sulfur (P₄S₁₀). Liquid electrolyte, 4 M LiFSI salt dissolved in DME, was added to the cell to wet the cell components. The cell was then sealed. After assembly, the cell was rested for 24 h. This time was sufficient to cause the metallic Li to lithiate the SC active material of the cathode layer. The cathode active material was converted to LiSC, with Li ions and electrons directly transferred to the SC to convert it to the LiSC compound. The assembled cell, in the discharged state after forming the LiSC, was charged to a voltage of 2.6 V by applying a current density of 0.2 mA cm⁻², equivalent to 0.1 C, which induced deposition (plating) of metallic Li on the copper current collector. The solid electrolyte was formed in situ (during charging) from the solid electrolyte precursor whereby the Li for the conversion comes from the cathode side. A reaction between the metallic Li and the solid electrolyte precursor forms a lithiated solid compound, e.g. Li₃PS₄ or LiₓP_{y}S_{z} where x, y, and z >0, thus forming the solid electrolyte, and metallic Li is placed underneath the solid electrolyte during charging of the cell. The cell was then discharged at a rate of 0.1 C to a voltage of 1 V to dissolve the metallic Li from the copper foil surface and lithiate the SC. The cell was then cycled at a rate of at least 0.2 C multiple times.

In some embodiments, a layer of metallic Li is in contact with the solid electrolyte precursor, e.g. phosphorous-sulfur compound (P₄S₁₀), before or during cell assembly, whereby a reaction between the metallic Li and solid electrolyte precursor forms a lithiated solid compound, e.g. Li₃PS₄ or LiₓP_{y}S_{z} where x, y, and z >0, thus forming the solid electrolyte before charging the cell. During charging, metallic Li is electrodeposited underneath the solid electrolyte in contact with the current collector. Alternatively, a solid electrolyte, e.g. Li₃PS₄ or LiₓP_{y}S_{z} where x, y, and z >0, can be coated on the copper foil rather than or in addition to creation by an in-situ reaction between Li and a precursor. Herein, during the first charge, metallic Li is placed underneath the solid electrolyte.

In some embodiments, SC active material is mixed with carbon black and PAA in the ratio of 9:1:1 by weight, respectively, and mixed with water to form an aqueous slurry, which was coated on a first metallic current collector, e.g. carbon-coated aluminum, after which it was dried at 70° C. for 1 h in air and for at least 3 h under vacuum. An electrolyte containing 4 M LiFSI salt dissolved in 1,2-DME solvent was added on the cathode layer. Then, a 35 μm thick metallic Li foil (14 mm diameter) was placed on the exterior surface of the cathode. The electrolyte added between the metallic Li layer and the cathode layer promoted adhesion between metallic Li layer and cathode layer. In addition, the liquid electrolyte promoted wetting of the porous cathode layer and facilitated lithiation of the SC to form an LiSC compound.

In some embodiments, a 16 mm diameter copper foil current collector (10 μm thick, 16 mm diameter) with no anode active material (e.g. metallic Li) on it was used as a second metallic foil current collector and coated with a solid electrolyte precursor, e.g. phosphorous sulfide (P₄S₁₀) The solid electrolyte layer on the copper current collector enabled use of smaller amount of liquid electrolyte between the metallic Li reductant and the cathode layer.

Liquid electrolyte, 4 M LiFSI salt dissolved in DME, was added to the cell to wet the cell components. The cell was then sealed. After assembly, the cell was rested for 24 h. This time was sufficient to cause the metallic Li to lithiate the SC active material of the cathode layer. The cathode active material was converted to LiSC, with Li ions and electrons directly transferred to the SC to convert it to the LiSC compound. Because the assembled cell was in the discharged state after forming the LiSC or lithiated SC, the cell was charged to a voltage of 2.6 V by applying a current density of 0.2 mA cm⁻², equivalent to 0.1 C, which induced deposition (plating) of metallic Li on the copper current collector. The solid electrolyte was formed in situ (during charging) from the solid electrolyte precursor whereby the Li for the conversion comes from the cathode side. A reaction between the metallic Li and solid electrolyte precursor forms a lithiated solid compound, e.g. Li₃PS₄ or LiₓP_{y}S, where x, y, and z >0, thus forming the solid electrolyte and metallic Li is placed underneath the solid electrolyte during charging of the cell. The cell was then discharged at a rate of 0.1 C to a voltage of 1 V to dissolve the metallic Li from the copper foil surface and lithiated the SC. The cell was then cycled at a rate of at least 0.2 C multiple times.

In some embodiments, a layer of metallic Li is in contact with the solid electrolyte precursor, e.g. phosphorous-sulfur compound (P₄S₁₀), before or during cell assembly, whereby a reaction between the metallic Li and solid electrolyte precursor forms a lithiated solid compound, e.g. Li₃PS₄ or LiₓP_{y}S_{z} where x, y, and z >0, thus forming the solid electrolyte before charging the cell. During charging, metallic Li is placed underneath the solid electrolyte.

In some embodiments, the LiSC compound is formed before assembling the cell and the excess or remaining metallic Li layer used in the formation is removed. In some embodiments, the excess or remaining metallic Li layer is retained in the cell after forming the LiSC. In some embodiments, all the metallic Li layer is utilized in forming LiSC during the formation cycle(s) before cell assembly.

In some embodiments, SC active material was mixed with carbon black and PAA in the ratio of 9:1:1 by weight, respectively, and mixed with water to form an aqueous slurry, which was coated on a first metallic current collector, carbon-coated aluminum, after which it was dried at 70° C. for 1 h in air and for at least 3 h under vacuum. A 35 μm thick metallic Li foil (14 mm diameter) was placed on the exterior surface of the cathode. A polymer separator based on 12 μm polyethylene coated with 4 μm ceramic (e.g. aluminum oxide) was placed between the cathode and a second metallic foil current collector. A 16 mm diameter copper foil current collector (10 μm thick, 16 mm diameter) with no anode active material was used as a second metallic foil current collector and coated with a solid electrolyte precursor, P₄S₁₀. No liquid electrolyte was added to the cell. After cell assembly, the cell was sealed and rested for 24 h.

Metallic Li lithiated the SC active material of the cathode layer. The cathode active material was converted to LiSC, with Li ions and electrons directly transferred to the SC to convert it to the LiSC compound. Because the assembled cell was in the discharged state after forming the LiSC or lithiated SC, the cell was charged to a voltage of 2.6 V by applying a current density of 0.2 mA cm ⁻², equivalent to 0.1 C, which induced deposition (plating) of metallic Li on the copper current collector. The solid electrolyte was formed in situ (during charging) from the solid electrolyte precursor whereby the Li for the conversion comes from the cathode side. A reaction between the metallic Li and solid electrolyte precursor formed a lithiated solid compound, e.g. Li₃PS₄ or LiₓP_{y}S_{z} where x, y, and z >0, thus forming the solid electrolyte. Metallic Li was then deposited underneath the solid electrolyte and upon the copper foil of the anode current collector during charging of the cell. The cell was then discharged at a rate of 0.1 C to a voltage of 1 V to dissolve the metallic Li from the copper foil surface and lithiated the SC. The cell was then cycled at a rate of at least 0.2 C multiple times.

In some embodiments, a layer of metallic Li is in contact with the solid electrolyte precursor, e.g. a phosphorous-sulfur compound (P₄S₁₀), before or during cell assembly, whereby a reaction between the metallic Li and solid electrolyte precursor forms a lithiated solid compound, e.g. Li₃PS₄ or LiₓP_{y}S_{z} where x, y, and z >0, thus forming the solid electrolyte before charging the cell. During charging, metallic Li is placed underneath the solid electrolyte. In some embodiments, particles of solid electrolyte precursor were mixed with SC cathode active material to facilitate Li transport in the cathode layer.

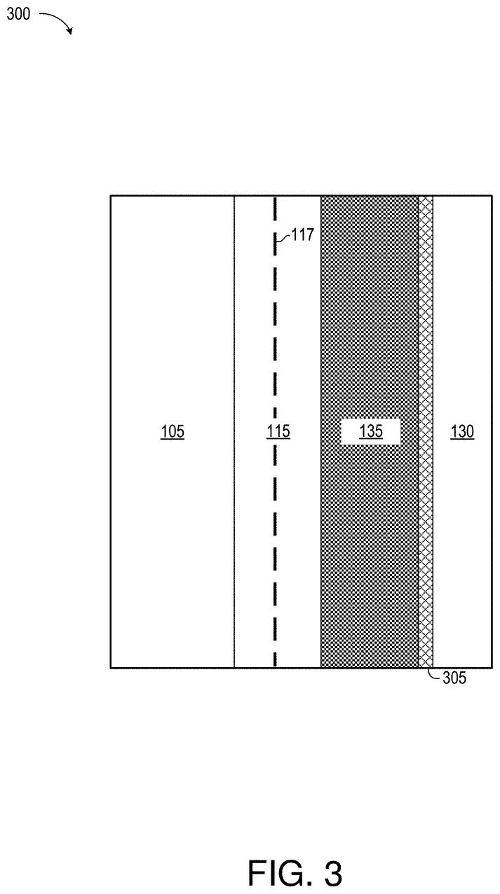

FIG. 3 depicts a rechargeable energy storage cell 300 that is like storage cells 100 and 150 of FIGS. 1A and 1B with like-identified elements being the same or similar. This embodiment is lithiated with a layer 305 sandwiched between cathode active layer 135 and cathode current collector 130. When cell 300 is thus assembled, porous cathode layer 135 allows electrolyte 115 to create an ion path from Li layer 305 to anode current collector 105. Cathode layer 135 absorbs the Li metal during subsequent discharges so that Li layer 305 is or is largely absent in normal use. A dopant layer of e.g. aluminum or boron can be added to either side of cathode layer 135 to be absorbed into the cathode material in the manner detailed above in connection with FIG. 1B.

Lithium layer 305 is shown on only one side of cathode current collector 130 but can be on both sides and can be applied to either or both sides as a discrete film or films. In a continuous process, for example, a perforated 20 μm Li foil is applied to both sides of an aluminum cathode-side current collector by roller and pressure. In other embodiments, the Li layer or layers can be formed on the current collector. In one embodiment, for example, Li layer 305 is electrodeposited to a thickness of 20 μm in an electrolyte comprising a Li salt dissolved in an organic solvent, e.g. 4 M Li bis(fluorosulfonyl)imide. In one embodiment, the deposition is conducted at a current density of about 0.4 mA cm⁻² for about 10 hours, producing deposited Li passivated by solid electrolyte interphase comprising decomposition products of the electrolyte. Layer 305 can be e.g. powdered, granular, or a paste in other embodiments.

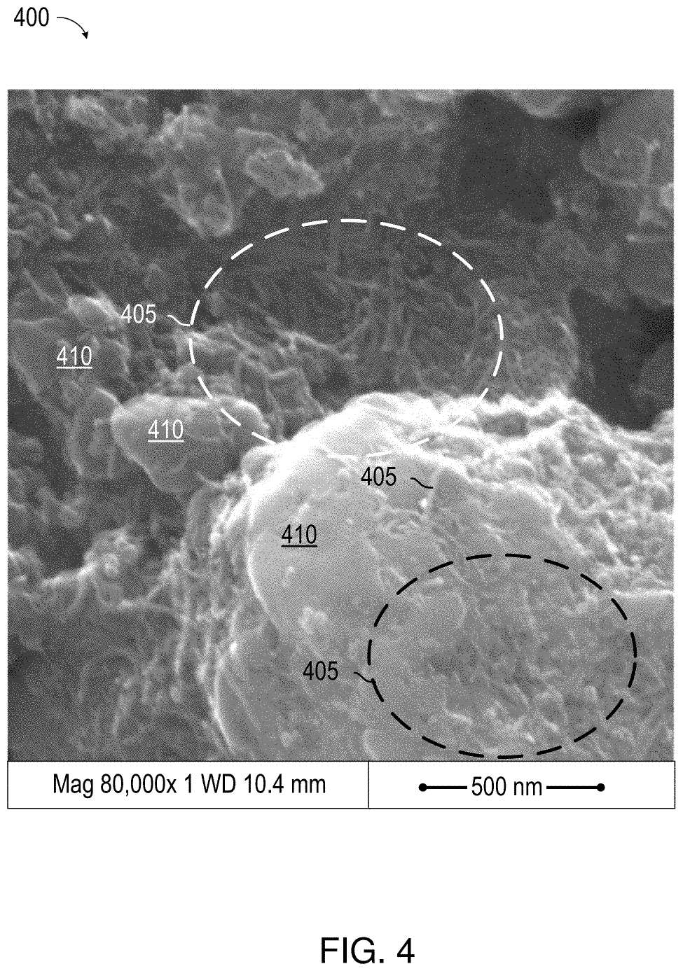

FIG. 4 is a SEM image at 80,000× magnification of an active surface of an electrode 400, a cathode for use in an energy-storge device. The active surface of electrode 400 exchanges Li ions with an electrolyte (not shown). Electrode 400 includes a conductive framework of tangled nanofibers 405, carbon nanotubes in this example, with lumps 410 of amorphous carbon-sulfur distributed within the tangled nanofibers. The amorphous carbon-sulfur lumps 410 are of carbon bonded to sulfur via carbon-sulfur chemical bonds and to nanofibers 405 via chemical bonds. The strength of the chemical bonds secures sulfur atoms within electrode 400, and thus suppresses the formation of undesirable polysulfides that would otherwise reduce cell life. Tangled nanofibers 405 bind the active materials within electrode 400 while enhancing thermal and electrical conductivities of the active layer.

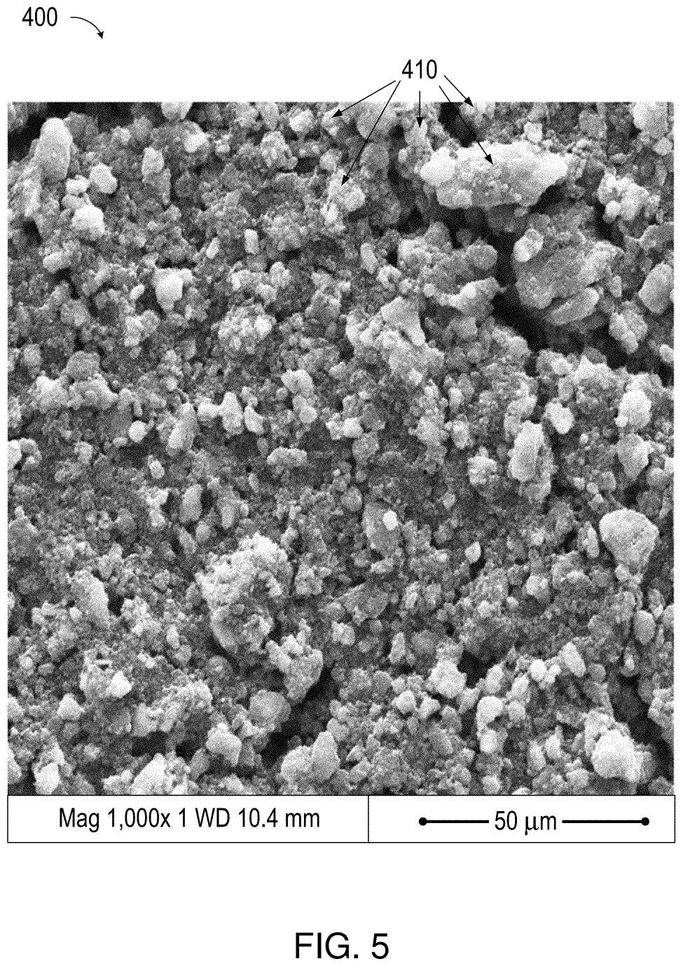

FIG. 5 is a SEM image of the active surface of electrode 400 at 1,000× magnification. Lumps 410 of various sizes are visible at this level of magnification, but the carbon nanotubes of the conductive network are too thin to resolve. Carbon nanotubes (tubes of carbon with diameters measured in nanometers) are of particularly high tensile strength and exhibit excellent thermal and electrical properties. Nanofibers of different sizes and types can be used in other embodiments. For example, the tangled nanofibers can include one or a combination of nanotubes, nanoribbons, graphene, carbon fibers, aluminum nanofibers, and nickel nanofibers.

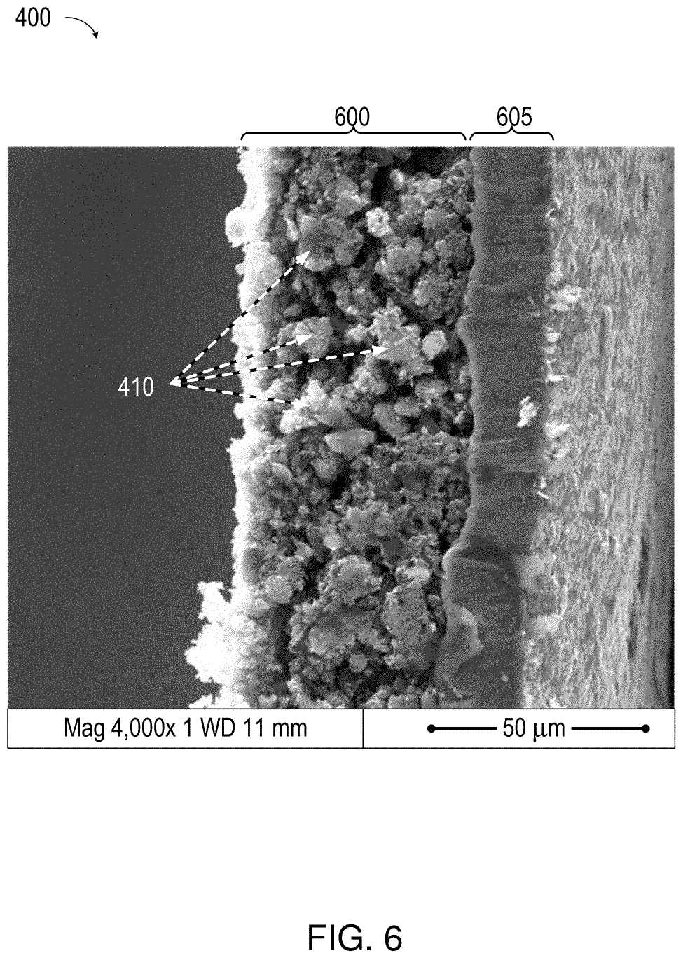

FIG. 6 is an SEM image of electrode 400 in cross section at 4,000× magnification. An active layer 600 of lumps 610 distributed within a conductive network of nanofibers (FIG. 4) is physically and electrically connected to an aluminum substrate 305 that serves as a current collector when electrode 400 is incorporated into e.g. a capacitor or electrochemical cell. Active layer 600 is about 50 μm thick, and substrate 605 about 20 μm, though this example is not limiting. Active layer 600 can be relatively dense, advantageously reducing electrolyte volume and thus cell volume. Some embodiments have cell cathode active material with a density of 0.4-1.2 g/cm³, a porosity of 20-70%, and a pore volume of 0.2-1.8 cm³/g.

Lumps 410 include sulfur that is reacted with and chemically bonded to the conductive network of nanofibers. Lumps 410 also include amorphous carbon with both sp2 and sp3 hybridized carbon atoms and are, like the sulfur, chemically bonded to the conductive network of nanofibers. The ratio of sp2 carbon atoms to sp3 carbon atoms is 50-90 at. % sp3 carbon atoms to 10-50 at. %, the sp2 indicative of aromatic rings. The chemical bonds securing lumps 410 to nanofibers 405 are predominantly covalent bonds. The resultant material is largely a sulfurized amorphous carbon that is tightly bonded to the conductive framework of tangled nanofibers, though some embodiments include as much as 20 wt % free sulfur, which is to say sulfur that is not chemically bonded to carbon either directly or via an intermediate atom or atoms (e.g., via one or more sulfur atoms, at least one of which is bonded to carbon).

The chemical stability of the active layer 600 suppresses polysulfide formation and thus allows for relatively high sulfur levels and concomitant Li storage. In some embodiments, for example, active layer 600 includes between 30 and 80 wt % sulfur. Active layer 600 can have low levels of oxygen, e.g. less than 10 wt %, which reduces the risks associated with thermal runaway. A polymer used in the formation of active layer 600 contributes hydrogen, in one example at a concentration of between five and twenty atomic percent of the active layer.

Lumps 410 are largely of amorphous carbon-sulfur with sp2 aromatic carbon clusters having an average maximum dimension of less than 20 nm dispersed within a matrix of sp3 carbon atoms. Dopants, like nitrogen and oxygen, can be added to improve conductivity and wettability for electrolyte or solvents. Other dopants, like aluminum and boron, can be added to counteract the electronegativity of elements and molecules that may be present in the cathode material. In some embodiments, the cathode material includes chemically significant concentrations of nitrogen, oxygen, or both from binders like poly(acrylonitrile-co-vinyl acid), or PAN, and poly(acrylic acid), or PAA, that are used in the formation process. The amorphous carbon-sulfur can include, for example, one or a combination of monocyclic or heterocyclic aromatic rings, and the heterocyclic rings can include at least one of oxygen, nitrogen, and sulfur.

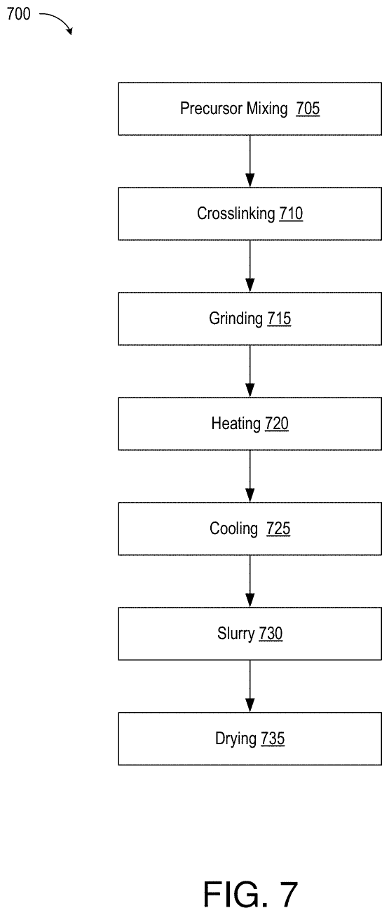

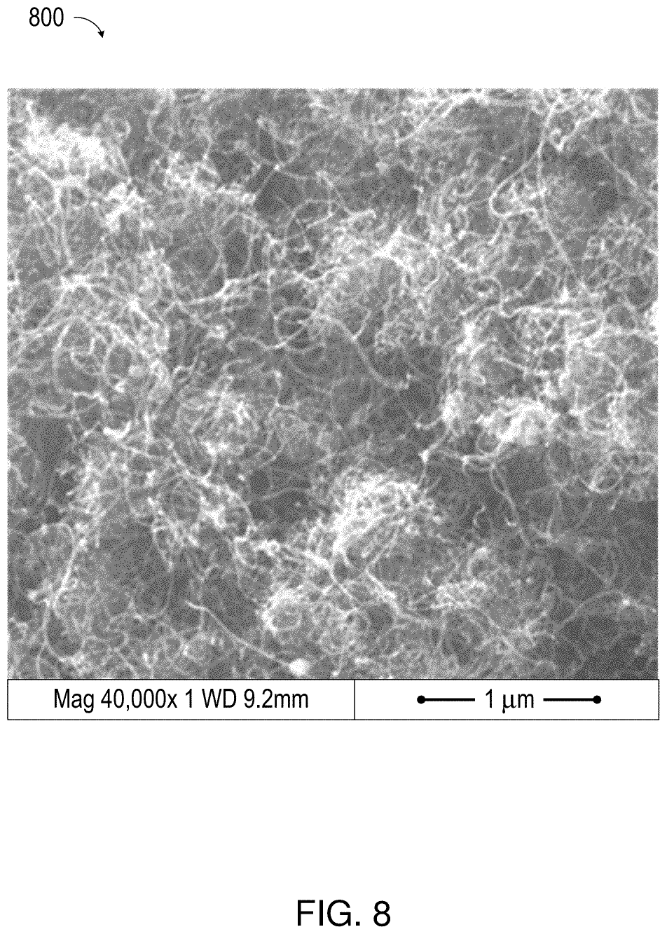

FIG. 7 is a flowchart depicting a method 700 of forming electrode 400 to make e.g. a cathode for an energy-storage device. First, at step 705, nanofibers are mixed with powders of sulfur and a polymer with a molecular weight of between 100,000 Dalton and 1,000,000 Dalton. In this example, carbon nanotubes 800 (FIG. 8) are mixed with a powder of PAN with an average molecular weight of 150,000 Dalton, and a powder of sulfur at a mass ratio of 1.5 wt %:16.4 wt %:82.1 wt %, respectively. This mixing can be done in a polyethylene container containing zirconia beads using a planetary mixer at 600 rpm for 10 min, then at 1,500 rpm for 10 min, yielding a fused/agglomerated powder. Carbon nanotubes 800 are e.g. 500 nm to 10 μm long and five to one-hundred nanometers in diameter. In some embodiments, the sulfur is admixed in vapor form rather than as a powder.

Next, in step 710, the agglomerated powder from step 705 is crosslinked and hardened, for example by further mixing at 1,500 rpm for at least ten additional minutes. Crosslinking refers to the formation of crosslinks, bonds that interlink polymer chains. Crosslinks can be covalent or ionic bonds. Step 710 heats the mixture to induce the crosslinking of the precursor, the heat reaching a temperature of between 40° C. and 90° C. The carbon nanotubes function as crosslinking, hardening agents. The crosslinked polymer chains and tangled nanofibers create a conductive carbon framework, or scaffold, that maintains the physical integrity of the crosslinked, hardened mixture during subsequent heating. The mixture from step 710 is removed and broken into chunks or pellets. The chunks or pellets from step 710 are ground using e.g. a mortar and pestle (step 715).

The precursor mix made with tangled carbon nanotubes was much harder and more abrasion resistant than one without the carbon nanotubes, which suggests that the carbon nanotubes play a role in producing hardened and rigid material by providing a rigid framework that supports lumps 410. The fused, hardened properties of the precursor mix from step 715 indicate that the transformation was not mere branching of the polymer chains but is also accompanied by cros slinking of the polymer chains aided by the sulfur and heat, thus restricting mobility of the chains during the subsequent high-temperature treatment.

Next, in step 720, the ground, agglomerated powder mixture is transferred to a furnace that is evacuated of air, filled with an inert gas (e.g. argon or nitrogen) and heated at a reaction temperature of 450° C. for 6 hours under the inert gas in a quartz tube using a split-tube furnace. This heat treatment, above the glass-transition temperature and below the decomposition temperature of the PAN polymer, pyrolyzes the PAN to chemically bond carbon from the PAN to the nanofibers and the sulfur, thus forming amorphous carbon-sulfur chemically bonded to the nanofibers. The heating additionally drives off constituent hydrogen and nitrogen, though some hydrogen and nitrogen can remain after the process. Steps 705 through 720 can be conducted absent some or all of the nanotubes to make sulfurized-carbon granules. Carbon nanomaterials or additional carbon nanomaterials of the same or a different type (e.g., ribbons versus tubes of the same or different lengths) can then be incorporated with the sulfurized-carbon granules via mixing and heating. The material is then cooled for e.g. one hour with the aid of a fan (step 725).

Cooled material from step 725 was characterized with thermogravimetric-mass spectroscopy (TG-MS) analysis and a significant mass loss of about 65 wt % was observed upon heating from room temperature to 1,000° C., the residual 35 wt % consisting primarily of carbon. The lost mass was primarily sulfur, and also included nitrogen, oxygen, and hydrogen that had been bonded to the conductive framework with SC. The sulfur content prior to heating was determined to be about 40 wt % of the cooled material from step 725.

The material from cooling step 725 is mixed with a powdered carbon (e.g. acetylene black), a binder, and an organic solvent or water to form a slurry (step 730). The sulfur in the material from step 725 is strongly bonded to carbon. The resultant chemical stability allows the material to be combined with inexpensive and environmentally friendly water without producing significant levels of poisonous, corrosive, and flammable hydrogen sulfide. For example, in one experiment using water to form a slurry, a detector with a detection limit of 0.4 ppm failed to detect hydrogen sulfide. The resistance to hydrogen-sulfide formation is due to the strong bonding between the sulfur and carbon.

The slurry can contain one or more water-soluble binders, e.g. PAA, carboxymethylcellulose, or styrene butadiene rubber. The binder and carbon additive can compose from e.g. 2 to 30 wt % of the solid mass. The slurry is spread over a conductor (e.g. an aluminum foil) and dried (step 735) by e.g. freeze drying and/or heating in dry air. The dried cathode layer is compressed e.g. by passing the foil between rollers. In an embodiment in which the dried slurry and underlying foil are together about 100 microns, the compression reduces cathode-layer thickness to between 50 and 90 microns, depending on the mass loading, with negligible impact on the foil. Mass loading of sulfurized-carbon cathodes can be e.g. 2 to 10 mg/cm², with a final sulfur content of e.g. from 30 to 80 wt %.

“Dry-electrode” embodiments omit steps 730 and 735. Rather than adding a liquid to form a slurry, the material from step 725 can be compressed into a dry film over a current collector or can be compressed into a dry film before application to the current collector. The drying step can thus be omitted. The cathode with the dried, compressed layer from step 735 or a dry-electrode process can be incorporated into a Li-metal cell. During discharge, Li metal oxidized at the anode releases Li ions through the electrolyte to the cathode. Cathodes from method 700 are compatible with other types of anodes, including those that incorporate porous carbon and silicon to store active metals (e.g., Li, Mg, Al, Na, and K) and their ions.

Returning to heating step 720, the sulfur content of active layer 600 was varied by tuning the reaction temperature between 300° C. and 600° C. At temperatures lower than 450° C., the mass loss upon heating during TG-MS analysis was greater than about 65 wt %. At temperatures above 450° C., the mass loss upon heating during TG-MS analysis is lower than about 65 wt %. Below 300° C. and above 600° C., the Li storage capacity of the electrode made from the material was lower than obtained from materials produced between 300° C. and 600° C.

The size of lumps 410 and the conductivity of active layer 600 can be varied. In a synthesis similar to the method of FIG. 7, the mixed precursor material was heated to between 100° C. and 250° C. to crosslink the precursor material. The crosslinked material was heated again, this time to between 300° C. and 500° C. to generate SC; and yet again to between 500° C. and 600° C. to promote further carbonization and/or graphitization, which increases the size of graphitic domains in the SC. Larger graphitic domains increase the ratio of sp2 to sp3 carbon, which increases the ratio of aromatic sp2 to sp3.

The material of step 720 includes graphitic domains or clustered aromatic carbon rings in the SC. The size of the domains or clusters can be increased for improved electrical conductivity. In one embodiment, for example, the domains or clusters were enlarged by subjecting the material to heat treatments up to a temperature of at least 600° C. for a period between one microsecond and one minute. The rapid heat treatment was induced by preheating the reactor to a temperature of at least 600° C. and moving the SC from a cold zone to the hot zone. These heat treatments also increase the ratio of sp2 to sp3 carbon and reduce hydrogen content. Heat treatment above 600° C. for more than an hour leads to a significant decrease in Li storage capacity of the material.

The foregoing method of making an electrode is not limiting. Other discrete or continuous processes can also be used. In one embodiment, for example, the discrete process of FIG. 7 is adapted to a continuous roll-to-roll process in which the active material is formed on one or both sides of a roll of aluminum foil.

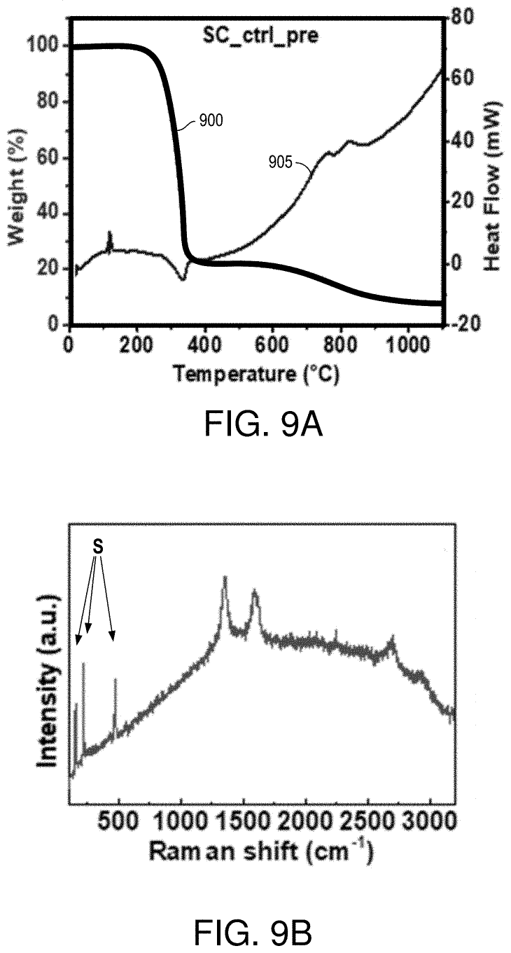

FIG. 9A depicts a thermogravimetric (TG) plot 900 and differential scanning calorimetric (DSC) plot 905 of the precursor mixture from step 705 of FIG. 7. Without crosslinking, the material rapidly loses sulfur above about 300° C.

FIG. 9B depicts the Raman spectrum of the precursor mixture from step 705 of FIG. 7 Raman shifts below about 500 cm⁻¹ indicate the presence of elemental sulfur.

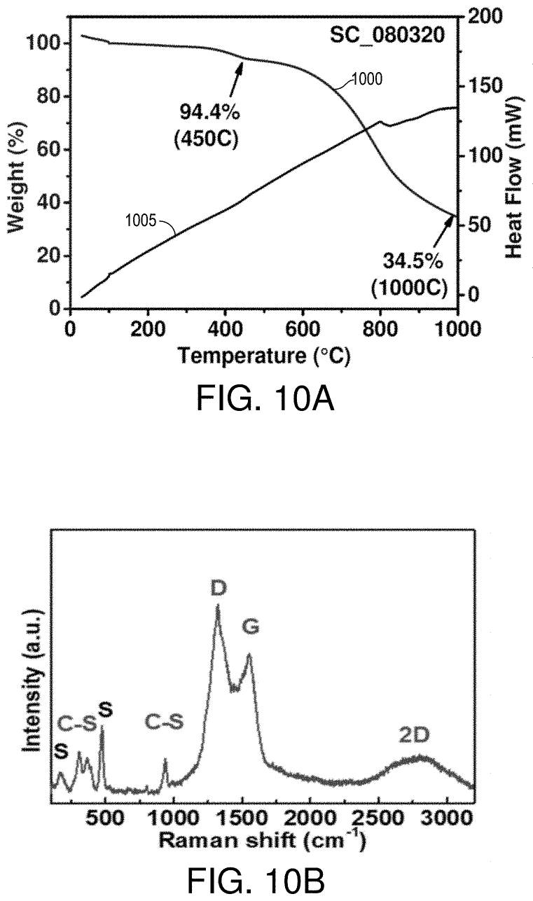

FIG. 10A depicts a TG plot 1000 and DSC plot 1005 of the output from step 735 of FIG. 7, the active cathode layer 600 in accordance with the embodiment of FIG. 6. With crosslinking and the subsequent heat treatment, the material retains sulfur far beyond the 300° C. of the precursor from step 750. In one example, 94.4% of the sulfur was retained up to 450° C. This demonstrates a chemical stability that prevents active cathode layers of this material from readily decomposing into polysulfides that escape into the electrolyte.

FIG. 10B is a Raman spectrum of a conductive framework of SC showing carbon sulfur (C—S) peaks, sulfur (S) peaks, D, G, and 2D peaks. The C—S peaks are indicative of carbon-sulfur chemical bonds, due to bonding of sulfur to amorphous carbon and the carbon nanotubes of the conductive framework of SC. The S peaks are indicative of sulfur-sulfur chemical bonds in a sulfur chain attached to the carbon. Thus, some of the sulfur atoms are bonded to only sulfur atoms (S—S) and some are bonded to both sulfur and carbon atoms (C—S—-S). The D, G, and 2D modes include contributions from the amorphous carbon and carbon nanotubes in the conductive framework of SC. The D mode, originating from the presence of six-membered rings, is activated by the presence of defects. The G mode confirms the sp2 carbon structure of the carbon nanotubes. The 2D mode, an overtone of the D mode, indicates the presence of six-membered rings and its shape provides structural and electronic structure about the conductive framework of SC. Because the 2D mode is quite noticeable relative to other peaks, it indicates the presence of clustered aromatic rings that provide conductivity in the conductive framework with SC. The broadness of the 2D peak confirms the amorphous carbon in the SC whereby sp2 carbon atoms are organized as clusters of six-membered rings that constitute a short-range order (on the order of several nanometers) before defects such as sp3 carbon, non-carbon atoms, five-membered rings, and/or seven-membered rings, are encountered.

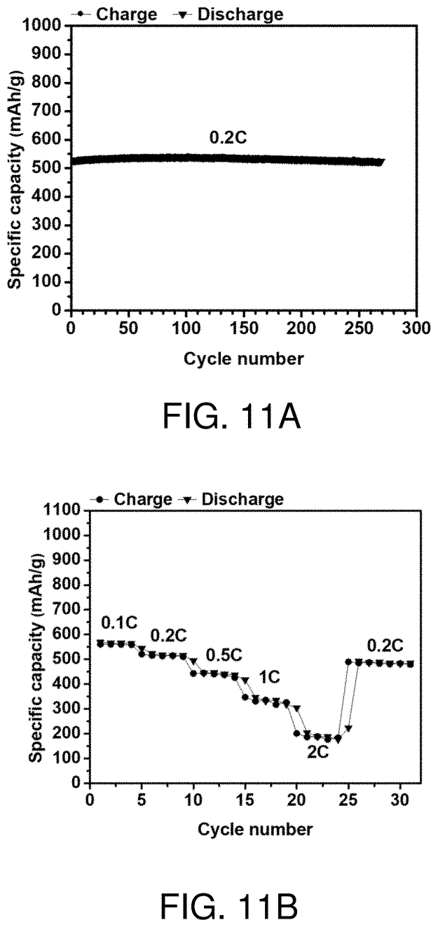

FIG. 11A plots the cycling performance (charge/discharge) of an electrode in accordance with one embodiment. In this example, the electrode material includes SC (active material within a sulfurized framework), carbon black (conductive additive), and PAA binder at a ratio of 95:5:5, coated from an aqueous (water) slurry on carbon-coated aluminum foil and dried. In one embodiment, the carbon-coated aluminum comprises an aluminum foil 16 um thick with both sides coated with a 1 μm layer of carbon of an areal density of 0.5 g/m². The carbon protects the aluminum from corrosion caused by the fluorinated electrolyte. It also promotes adhesion between the current collector and the cathode material. The gravimetric capacity (mAh/g) of the electrode is based on the mass of the active material. The mass of the electrode material is 5 mg/cm² and the areal capacity at 0.2 C is about 2.4 mAh/cm².

FIG. 11B plots the rate performance (charge/discharge) of an electrode (a half cell) in accordance with another embodiment. The x axis represents charge cycles and the y axis the gravimetric capacity of the SC. In this example the active electrode material includes a conductive framework with SC, carbon black (a conductive additive), and a polyvinylidene difluoride (PVDF) binder at a ratio of 95:5:5. This composition was coated from an N-Methylpyrrolidone (NMP) slurry on carbon-coated aluminum foil that will serve as current collector. The mass of the electrode material, after drying, is 4.5 mg/cm² and the areal capacity at 0.2 C is about 2.2 mAh cm⁻². These data show that the gravimetric capacity of the half cell at 0.2 C recovers after repeated charge and discharge cycles at 2 C.

Lithium ions are not the only suitable charge carriers; other alkali metals can be used. In some embodiments that employ sodium (Na), for example, SC active material is mixed with carbon black and PAA in the ratio of 9:1:1 by weight, respectively, and mixed with water to form an aqueous slurry, which is coated on a first metallic current collector, e.g. carbon-coated aluminum. The slurry coat is then dried at 70° C. for 1 h in air and for at least 3 h under vacuum. An electrolyte containing 4 M sodium bis(fluorosulfonyl)imide (NaFSI) salt dissolved in 1,2-DME solvent is added on the cathode layer. Then, a 35 μm thick metallic Na foil (14 mm diameter) is placed on the exterior surface of the cathode. The electrolyte added between the metallic Na layer and the cathode layer promotes adhesion between metallic Na layer and cathode layer. In addition, the liquid electrolyte promotes wetting of the porous cathode layer and facilitates sodiation of the SC to form an NaSC compound.

Alkaline earth metals can also serve as charge carriers. In some embodiments that employ magnesium (Mg), for example, SC active material is mixed with carbon black and PAA in the ratio of 9:1:1 by weight, respectively, to form an aqueous slurry, which is coated on a first metallic current collector, e.g. carbon-coated aluminum before drying at 70° C. for 1 h in air and for at least 3 h under vacuum. An electrolyte containing 4 M magnesium bis(fluorosulfonyl)imide (MgFSI) salt dissolved in 1,2-DME solvent is added on the cathode layer. Then, a 35 μm thick metallic Mg foil (14 mm diameter) is placed on the exterior surface of the cathode. The electrolyte added between the metallic Mg layer and the cathode layer promotes adhesion between metallic Mg layer and cathode layer. In addition, the liquid electrolyte promotes wetting of the porous cathode layer and facilitates magnesiation of the SC to form an MgSC compound.

While the Li layers are continuous films in the foregoing examples, metal layers can be introduced as e.g. perforated sheets, screens, or loose or agglomerated particles, wires, or rods that assemble into a layer during device assembly. A slurry of metal particles and electrolyte can be used in lieu of or with the electrolyte. Other variations of these embodiments will be obvious to those of ordinary skill in the art. Therefore, the spirit and scope of the appended claims should not be limited to the foregoing description. Only those claims specifically reciting “means for” or “step for” should be construed in the manner required under the sixth paragraph of 35 U.S.C. § 112.

What is claimed is:

1. An electrode comprising:
a current collector;
carbon-sulfur physically and electrically connected to the current collector, the carbon-sulfur including carbon bonded to sulfur via carbon-sulfur chemical bonds; and
a layer of an alkali metal physically and electrically connected to the carbon-sulfur.

2. The electrode of claim 1, wherein the carbon sulfur is amorphous.

3. The electrode of claim 1, further comprising a lithiophilic adhesive coating between the carbon-sulfur and the alkali-metal layer.

4. The electrode of claim 3, wherein the adhesive coating is of a coating material, the electrode further comprising a compound of the alkali metal and the coating material between the adhesive coating and the alkali-metal layer.

5. The electrode of claim 1, further comprising a cathode-dopant layer in contact with the alkali-metal layer.

6. The electrode of claim 5, wherein the cathode-dopant layer comprises a majority element by atomic percent having an electronegativity less than that of the carbon.

7. The electrode of claim 6, wherein the cathode-dopant layer comprises at least one of aluminum and boron.

8. The electrode of claim 1, wherein the carbon-sulfur further comprises the alkali metal with a thickness of at least 5 μm.

9. The electrode of claim 1, further comprising nanofibers, wherein the carbon-sulfur is distributed within the nanofibers.

10. The electrode of claim 9, wherein the nanofibers are tangled.

11. The electrode of claim 9, wherein the nanofibers consist essentially of carbon.

12. The electrode of claim 11, wherein the lithiated carbon-sulfur further including second carbon bonded to the nanofibers.

13. The electrode of claim 1, wherein the alkali-metal layer is porous.

14. The electrode of claim 13, wherein the alkali-metal layer is perforated.

15. An anode-free electrochemical cell comprising the electrode of claim 1 and a second current collector.

16. The anode-free electrochemical cell of claim 15, wherein the second current collector comprises copper.

17. The anode-free electrochemical cell of claim 15, further comprising an electrolyte separating the layer of alkali-metal layer from the second current collector.

18. The anode-free electrochemical cell of claim 17, further comprising a separator disposed between the layer of alkali-metal layer and the second current collector.

19. The anode-free electrochemical cell of claim 17, further comprising a second electrolyte separating the alkali-metal layer from the second current collector.

20. The anode-free electrochemical cell of claim 19, wherein the second electrolyte is solid.

21. The anode-free electrochemical cell of claim 20, wherein the second electrolyte physically contacts the alkali-metal layer.

22. The anode-free electrochemical cell of claim 21, wherein the second electrolyte physically contacts the second current collector.

23. The electrode of claim 1, further comprising a conductive framework, wherein the conductive framework and the carbon-sulfur comprise less than 10 wt % oxygen.

24. The electrode of claim 23, wherein the conductive framework and the carbon-sulfur comprise more than 30 wt % sulfur.

25. The electrode of claim 1, wherein the carbon-sulfur includes sp2 carbon atoms and sp3 carbon atoms, and wherein the ratio of sp2 carbon atoms to sp3 carbon atoms is 50-90% sp3 carbon atoms to 10-50%.

26. The electrode of claim 1, wherein the carbon-sulfur contains sp2 aromatic carbon clusters having an average maximum dimension of less than 20 nm dispersed within a matrix of sp3 carbon atoms.
